(19) United States
(12) Patent Application Publication
(10) Pub. No.: US 2024/0207964 A1
(43) Pub. Date: Jun. 27, 2024

(54) METHODS AND APPARATUS TO REDUCE NUISANCE TRIPS OF CIRCUIT LIMITERS WHILE WELDING

(71) Applicant: Illinois Tool Works Inc., Glenview, IL (US)

(72) Inventor: Craig Steven Knoener, Appleton, WI (US)

(21) Appl. No.: 18/545,294

(22) Filed: Dec. 19, 2023

Related U.S. Application Data
(60) Provisional application No. 63/434,325, filed on Dec. 21, 2022.

(51) Int. Cl. B23K 9/10; B23K 9/095; H02M 1/32

(52) U.S. Cl. CPC B23K 9/1043; B23K 9/095; H02M 1/32

(57) ABSTRACT

Example welding power supplies include: power conversion circuitry configured to convert input power to welding power, and to output the welding power; and control circuitry configured to: in response to detecting a short circuit between a welding electrode and a workpiece, controlling the power conversion circuitry to increase a current of the welding power; and in response to identifying a predetermined condition that would cause a circuit limiter connected to the input power to trip, control the power conversion circuitry to reduce at least one of an input current of the input power or an output current of the welding power to avoid tripping the circuit limiter.

### RELATED APPLICATIONS

The present application claims the benefit of U.S. Provisional Patent Application Ser. No. 63/434,325, filed Dec. 21, 2022, entitled “METHODS AND APPARATUS TO REDUCE NUISANCE TRIPS OF CIRCUIT LIMITERS WHILE WELDING.” The entirety of U.S. Provisional Patent Application Ser. No. 63/434,325 is expressly incorporated herein by reference.

### FIELD OF THE DISCLOSURE

This disclosure relates generally to welding and, more particularly, to methods and apparatus to reduce nuisance trips of circuit limiters while welding.

### SUMMARY

Arc fault circuit interrupters (AFCI) are a type of circuit breaker that disconnects a load when certain conditions are present that are indicative of arcing in the circuit.

### SUMMARY

Methods and apparatus to reduce nuisance trips of circuit limiters while welding are disclosed, substantially as illustrated by and described in connection with at least one of the figures, as set forth more completely in the claims.

### BRIEF DESCRIPTION OF THE DRAWINGS

FIG. 1 is a block diagram of an example welding system including a remote wire feeder and configured to provide synergic power control, in accordance with aspects of this disclosure.

FIG. 2 is a block diagram of another example welding system configured to provide synergic power control with a welding-type power supply having an integrated wire feeder, in accordance with aspects of this disclosure.

FIG. 3 is a block diagram of an example implementation of the power conversion circuitry of FIGS. 1 and/or 2.

FIG. 4 is a flowchart representative of example machine readable instructions which may be executed by the control circuitry of FIGS. 1 and/or 2 to control the power conversion circuitry to reduce nuisance trips of circuit limiters while welding.

FIG. 5 is a flowchart representative of example machine readable instructions which may be executed by the control circuitry of FIGS. 1 and/or 2 to control the power conversion circuitry based on short circuit clear process.

FIG. 6A is a graph illustrating an output of a welding power supply during a conventional short circuit clearing process that is subject to nuisance trips of a current limiter.

FIG. 6B is a graph illustrating an output of a welding power supply during a disclosed example short circuit clearing process implemented using the example power supply of FIGS. 1 and/or 2 that reduces or prevents nuisance trips of a current limiter.

FIG. 7 is an example user interface which may implement the user interfaces of FIGS. 1 and/or 2 to receive an input specifying a type and/or amperage limit associated with a circuit limiter at an input of the power supply.

The figures are not necessarily to scale. Where appropriate, similar or identical reference numbers are used to refer to similar or identical components.

### DETAILED DESCRIPTION

Use of conventional welding power supplies can result in tripping of circuit breakers, and particularly when AFCI-type circuit breakers are connected to the supply circuit of the welding power supply. As a result, conventional welding power supplies can experience sudden losses of power during a welding arc. Sudden losses of power can be more frequent during weld starts, but also occur during welding after the weld start. Conventional power supplies can often create conditions that cause AFCI circuit breaker trips during or following “hard” short circuits, which last longer (e.g., more than 5 milliseconds (ms)) than typical short circuits that occur during short arc welding processes (e.g., 5 ms or less).

Conventional welding power supplies are also susceptible to input circuit interruption when supplied by battery-powered power supplies and/or generators that output 120 VAC, which is used as the input to the welding power supply. Such conventional welding power supplies have a higher incidence of tripping the circuit interrupter during weld starts, and/or may have poorer weld starts, when supplied by battery-powered power supplies and/or generators that output 120 VAC.

Disclosed example welding power supplies reduce or prevent circuit limiter trips associated with performing welding using the welding power supply. Some example welding power supplies control a preregulator circuit of the welding power supply to limit the input current received from the supply circuit to less than a threshold input current. For example, the preregulator may reduce or limit the current drawn from an input power supply to less than a threshold input current. Additionally or alternatively, in some examples, the welding-type output is controlled to limit the power consumed during particular high power events (e.g., hard short circuits and immediately following hard short circuits).

Disclosed example power supplies reduce or prevent AFCI circuit breaker trips and/or battery/generator limiter trips, which are disruptive to productivity. Some disclosed examples also improve weld starts by reducing the power on the first short circuit of a welding operation, due to reducing excess growth of the ball on the end of the wire and allowing weld transfer to settle to a nominal state sooner.

As used herein, the term “welding-type power” refers to power suitable for welding, plasma cutting, induction heating, CAC-A and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, a “welding-type power supply” refers to any device capable of, when power is applied thereto, supplying welding, cladding, plasma cutting, induction heating, laser (including laser welding, laser hybrid, and laser cladding), carbon arc cutting or gouging and/or resistive preheating, including but not limited to transformer-rectifiers, inverters, converters, resonant power supplies, quasi-resonant power supplies, switch-mode power supplies, etc., as well as control circuitry and other ancillary circuitry associated therewith.

As used herein, a “weld voltage setpoint” refers to a voltage input to the power converter via a user interface, network communication, weld procedure specification, or other selection method.

As used herein, a “circuit” includes any analog and/or digital components, power and/or control elements, such as a microprocessor, digital signal processor (DSP), software, and the like, discrete and/or integrated components, or portions and/or combinations thereof.

As used herein, the term “remote wire feeder” refers to a wire feeder that is not integrated with the power supply in a single housing.

Disclosed example welding power supplies include: power conversion circuitry configured to convert input power to welding power, and to output the welding power; and control circuitry configured to: in response to detecting a short circuit between a welding electrode and a workpiece, controlling the power conversion circuitry to increase a current of the welding power; and in response to identifying a predetermined condition that would cause a circuit limiter connected to the input power to trip, control the power conversion circuitry to reduce at least one of an input current of the input power or an output current of the welding power to avoid tripping the circuit limiter.

In some example welding power supplies, the power conversion circuitry includes: a preregulator circuit configured to convert the input power to supply a DC bus; and a switched mode power supply configured to convert power from the DC bus to output the welding power. In some examples, the control circuitry is configured to control the preregulator circuit to limit the input current of the input power to supply the DC bus. In some example welding power supplies, the control circuitry is configured to control the switched mode power supply to reduce the output current of the welding power.

In some example welding power supplies, the control circuitry is configured to: monitor an input voltage of the input power; in response to a loss of input voltage during a welding operation, store an indication of a breaker trip in a non-volatile storage device prior to loss of power to the control circuitry and the storage device; and in response to identifying the indication of the breaker trip in the storage device, outputting an alert indicating that a circuit breaker trip occurred at the input power. In some example welding power supplies, the control circuitry is configured to: in response to detecting a clearing of the short circuit when the short circuit is a first short circuit of a welding operation or the short circuit persisted longer than a predetermined threshold time period prior to the clearing of the short circuit, control the power conversion circuitry to decrease the current at a first rate; and in response to detecting a clearing of the short circuit when the short circuit persisted less than the predetermined threshold time period and the short circuit is not the first short circuit of the welding operation, control the power conversion circuitry to decrease the current at a second rate that is slower than the first rate.

Some example welding power supplies further include a user interface configured to receive an input identifying at least one of a type of circuit limiter connected to the input power or an amperage associated with the circuit breaker connected to the input power. In some example welding power supplies, the control circuitry is configured to control the power conversion circuitry to limit the input current of the input power drawn by the power conversion circuitry to less than a first limit based on the input. In some example welding power supplies, the first limit is not more than 30 Amperes.

In some example welding power supplies, the input includes at least one of a standard circuit breaker type, an arc fault circuit interrupter circuit breaker type, a ground fault circuit interrupter type, a combination arc fault circuit interrupter-ground fault circuit interrupter circuit breaker type, or a generator circuit limiter type.

Some disclosed example welding power supplies include: power conversion circuitry configured to convert input power to welding power, and to output the welding power; a user interface configured to receive an input identifying at least one of a type of circuit limiter connected to the input power or an amperage associated with a circuit limiter connected to the input power; and control circuitry configured to control the power conversion circuitry to reduce nuisance trips of the circuit limiter.

In some example welding power supplies, the control circuitry is configured to control the power conversion circuitry to limit an input current of the input power drawn by the power conversion circuitry to less than a first limit based on the input. In some example welding power supplies, the control circuitry is configured to control the power conversion circuitry to limit the input current of the input power to less than a second limit during a first predetermined time period of a welding operation. In some example welding power supplies, the first limit is not more than 30 Amperes.

In some example welding power supplies, the control circuitry is configured to, based on the input, control a wire feeder to limit a wire feed speed to less than a wire feed speed setpoint for a predetermined duration following clearing of a first short circuit of a welding operation. In some example welding power supplies, the control circuitry is configured to, based on the input, control the power conversion circuitry to limit a voltage of the welding power to less than a voltage setpoint for a predetermined duration following clearing of a first short circuit of a welding operation.

In some example welding power supplies, the input includes at least one of a standard circuit breaker type, an arc fault circuit interrupter circuit breaker type, or a ground fault circuit interrupter type, a combination arc fault circuit interrupter-ground fault circuit interrupter circuit breaker type, or a generator circuit limiter type. In some example welding power supplies, the control circuitry is configured to, based on the input, control the power conversion circuitry to increase a current ramp rate for decreasing a welding current of the welding power in response to clearing of a first short circuit of a welding operation.

In some example welding power supplies, the control circuitry is configured to, based on the input, control the power conversion circuitry to increase a current ramp rate for decreasing a welding current of the welding power in response to clearing of short circuits that have at least a predetermined duration. In some example welding power supplies, the control circuitry is configured to, based on the input, control the power conversion circuitry to increase the current ramp rate to an upper limit of the current ramp rate of the power conversion circuitry in response to the clearing of short circuits that have at least the predetermined duration.

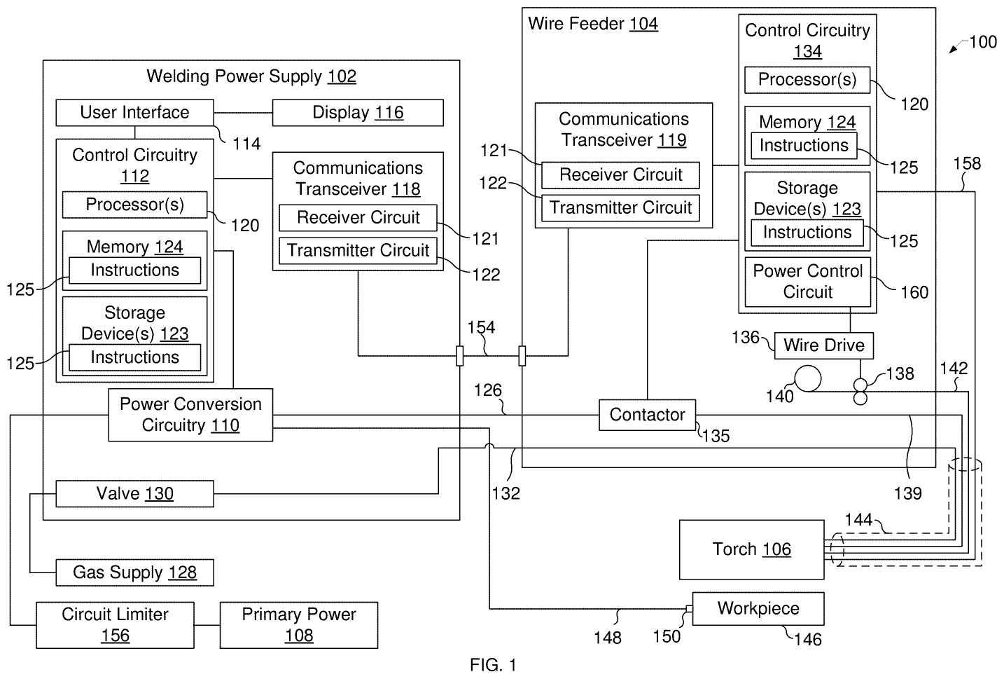

Turning now to the drawings, FIG. 1 is a block diagram of an example welding system 100 having a welding power supply 102, a wire feeder 104, and a welding torch 106. The welding system 100 powers, controls, and supplies consumables to a welding application. The example welding torch 106 is configured for gas metal arc welding (GMAW). In the illustrated example, the power supply 102 is configured to supply power to the wire feeder 104, and the wire feeder 104 may be configured to route the input power to the welding torch 106. In addition to supplying an input power, the wire feeder 104 supplies a filler metal to a welding torch 106 for various welding applications (e.g., GMAW welding, flux core arc welding (FCAW)).

The power supply 102 receives primary power 108 (e.g., from the AC power grid, an engine/generator set, a battery, or other energy generating or storage devices, or a combination thereof), conditions the primary power, and provides an output power to one or more welding devices in accordance with demands of the system 100. The primary power 108 may be supplied from an offsite location (e.g., the primary power may originate from the power grid). The power supply 102 includes a power conversion circuitry 110, which may include transformers, rectifiers, switches, and so forth, capable of converting the AC input power to AC and/or DC output power as dictated by the demands of the system 100 (e.g., particular welding processes and regimes). The power conversion circuitry 110 converts input power (e.g., the primary power 108) to welding-type power based on a weld voltage setpoint and outputs the welding-type power via a weld circuit.

In some examples, the power conversion circuitry 110 is configured to convert the primary power 108 to both welding-type power and auxiliary power outputs. However, in other examples, the power conversion circuitry 110 is adapted to convert primary power only to a weld power output, and a separate auxiliary converter is provided to convert primary power to auxiliary power. In some other examples, the power supply 102 receives a converted auxiliary power output directly from a wall outlet. Any suitable power conversion system or mechanism may be employed by the power supply 102 to generate and supply both weld and auxiliary power.

The power supply 102 includes control circuitry 112 to control the operation of the power supply 102. The power supply 102 also includes a user interface 114. The control circuitry 112 receives input from the user interface 114, through which a user may choose a process and/or input desired parameters (e.g., voltages, currents, particular pulsed or non-pulsed welding regimes, and so forth). The user interface 114 may receive inputs using any input device, such as via a keypad, keyboard, buttons, touch screen, voice activation system, wireless device, etc. Furthermore, the control circuitry 112 controls operating parameters based on input by the user as well as based on other current operating parameters. Specifically, the user interface 114 may include a display 116 for presenting, showing, or indicating, information to an operator. The control circuitry 112 may also include interface circuitry for communicating data to other devices in the system 100, such as the wire feeder 104. For example, in some situations, the power supply 102 wirelessly communicates with the wire feeder 104 and/or other welding devices within the welding system 100. Further, in some situations, the power supply 102 communicates with the wire feeder 104 and/or other welding devices using a wired connection, such as by using a network interface controller (NIC) to communicate data via a network (e.g., ETHERNET, 10BASE2, 10BASE-T, 100BASE-TX, etc.).

The control circuitry 112 includes at least one processor 120 that controls the operations of the power supply 102. The control circuitry 112 receives and processes multiple inputs associated with the performance and demands of the system 100. The processor 120 may include one or more microprocessors, such as one or more “general-purpose” microprocessors, one or more special-purpose microprocessors and/or ASICS, and/or any other type of processing device and/or logic circuit. For example, the processor 120 may include one or more digital signal processors (DSPs).

The example control circuitry 112 includes one or more storage device(s) 123 and one or more memory device(s) 124. The storage device(s) 123 (e.g., nonvolatile storage) may include ROM, flash memory, a hard drive, and/or any other suitable optical, magnetic, and/or solid-state storage medium, and/or a combination thereof. The storage device 123 stores data (e.g., data corresponding to a welding application), instructions (e.g., software or firmware to perform welding processes), and/or any other appropriate data. Examples of stored data for a welding application include an attitude (e.g., orientation) of a welding torch, a distance between the contact tip and a workpiece, a voltage, a current, welding device settings, and so forth.

The memory device 124 may include a volatile memory, such as random access memory (RAM), and/or a nonvolatile memory, such as read-only memory (ROM). The memory device 124 and/or the storage device(s) 123 may store a variety of information and may be used for various purposes. For example, the memory device 124 and/or the storage device(s) 123 may store processor executable instructions 125 (e.g., firmware or software) for the processor 120 to execute. In addition, one or more control regimes for various welding processes, along with associated settings and parameters, may be stored in the storage device 123 and/or memory device 124, along with code configured to provide a specific output (e.g., initiate wire feed, enable gas flow, capture welding current data, detect short circuit parameters, determine amount of spatter) during operation.

In some examples, the welding power flows from the power conversion circuitry 110 through a weld cable 126 to the wire feeder 104 and the welding torch 106. The example weld cable 126 is attachable and detachable from weld studs at each of the power supply 102 and the wire feeder 104 (e.g., to enable case of replacement of the weld cable 126 in case of wear or damage).

The example communications transceiver 118 includes a receiver circuit 121 and a transmitter circuit 122. Generally, the receiver circuit 121 receives data transmitted by the wire feeder 104 and the transmitter circuit 122 transmits data to the wire feeder 104. The example wire feeder 104 also includes a communications transceiver 119, which may be similar or identical in construction and/or function as the communications transceiver 118.

In some examples, a gas supply 128 provides shielding gases, such as argon, helium, carbon dioxide, and so forth, depending upon the welding application. The shielding gas flows to a valve 130, which controls the flow of gas, and if desired, may be selected to allow for modulating or regulating the amount of gas supplied to a welding application. The valve 130 may be opened, closed, or otherwise operated by the control circuitry 112 to enable, inhibit, or control gas flow (e.g., shielding gas) through the valve 130. Shielding gas exits the valve 130 and flows through a gas conduit 132 (which in some implementations may be packaged with the welding power output) to the wire feeder 104 which provides the shielding gas to the welding application. In some examples, the welding system 100 does not include the gas supply 128, the valve 130, and/or the gas conduit 132. In some other examples, the valve 130 is located in the wire feeder 104, and, the gas supply 128 is connected to the wire feeder 104.

In some examples, the wire feeder 104 uses the welding power to power the various components in the wire feeder 104, such as to power wire feeder control circuitry 134. As noted above, the weld cable 126 may be configured to provide or supply the welding power. The wire feeder control circuitry 134 controls the operations of the wire feeder 104. In some examples, the wire feeder 104 uses the wire feeder control circuitry 134 to detect whether the wire feeder 104 is in communication with the power supply 102 and to detect a current welding process of the power supply 102 if the wire feeder 104 is in communication with the power supply 102.

A contactor 135 (e.g., high amperage relay) is controlled by the wire feeder control circuitry 134 and configured to enable or inhibit welding power to continue to flow to a weld conductor 139 from the weld cable 126 for the welding application. In some examples, the contactor 135 is an electromechanical device. However, the contactor 135 may be any other suitable device, such as a solid state device, and/or may be omitted entirely and the weld cable 126 is directly connected to the output to the welding torch 106. The wire feeder 104 includes a wire drive 136 that receives control signals from the wire feeder control circuitry 134 to drive rollers 138 that rotate to pull wire off a spool 140 of wire. The wire drive 136 feeds electrode wire to the welding torch 106. The wire is provided to the welding application through a wire liner 142. Likewise, the wire feeder 104 may provide the shielding gas from the gas conduit 132. The example gas conduit 132, the example wire liner 142, and the example conductor 139 are combined in a torch cable 144. The electrode wire, the shield gas, and the power from the weld cable 139 are bundled together in a single torch cable 144 and/or individually provided to the welding torch 106.

The welding torch 106 delivers the wire, welding power, and/or shielding gas for a welding application. The welding torch 106 is used to establish a welding arc between the welding torch 106 and a workpiece 146. A work cable 148 couples the workpiece 146 to the power supply 102 (e.g., to the power conversion circuitry 110) to provide a return path for the weld current (e.g., as part of the weld circuit). The example work cable 148 is attachable and/or detachable from the power supply 102 for case of replacement of the work cable 148. The work cable 148 may be terminated with a clamp 150 (or another power connecting device), which couples the power supply 102 to the workpiece 146.

A communication cable 154 connected between the power supply 102 and the wire feeder 104, which enables bidirectional communication between the transceivers 118, 119. The communications transceivers 118 and 119 may communicate via the communication cable 154, via the weld circuit, via wireless communications, and/or any other communication medium. Examples of such communications include weld cable voltage measured at a device that is remote from the power supply 102 (e.g., the wire feeder 104).

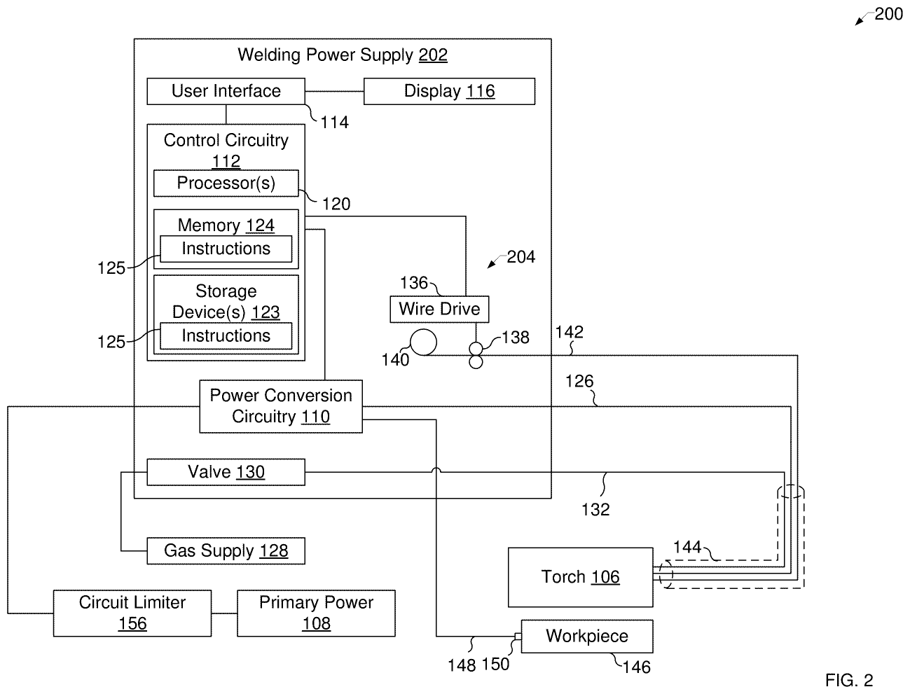

FIG. 2 is a block diagram of another example welding-type system 200 configured to provide synergic power control with a welding power supply 202 having an integrated wire feeder 204. The example welding power supply 202 includes the power conversion circuitry 110, control circuitry 112, the user interface 114, the display 116, the processor(s) 120, the storage devices(s) 123, the memory 124, the instructions 125, and the valve 130 of the example power supply 102 of FIG. 1.

In contrast with the example system 100, in the example of FIG. 2 the power supply 202 includes the integrated wire feeder 204 instead being connected to a remote wire feeder. The power supply 202 of FIG. 2 outputs welding-type power and electrode wire to the torch 106.

The integrated wire feeder 204 includes the wire drive 136, the drive rollers 138, and the wire spool 140, and feeds the wire through a torch cable 144 to the torch 106.

The example primary power 108 of FIGS. 1 and 2 is connected to a circuit limiter 156, such as a standard or conventional circuit breaker, a ground fault circuit interrupter (GFCI)-type circuit breaker, an AFCI-type circuit breaker, a combination AFCI/GFCI circuit breaker, a circuit-implemented current limiter, and/or any other type of circuit limiter 156. The circuit limiter 156 may, in response to detecting certain conditions based on the circuit limiter type, disconnect the primary power 108 from the power conversion circuitry 110, effectively turning off or resetting the welding power supply 102, 202. As discussed in more detail below, the example power supplies 102, 202 and power conversion circuitry 110 control input and output power to reduce (e.g., minimize) or prevent the incidence of circuit breaker trips, and particularly for AFCI-type circuit breakers and/or current limiters.

The example control circuitry 112 controls the power conversion circuitry 110 to respond to high power events, such as hard short circuits and/or the first short circuit of a welding operation, to quickly reduce the current and/or power to reduce the likelihood of a current limiter trip without sacrificing weld performance. For example, the control circuitry 112 may identify predetermined conditions that would cause the circuit limiter 156 to trip. The predetermined conditions may include conditions which have been theoretically and/or empirically determined to increase the likelihood of a circuit limiter trip by at least a threshold amount or to more than a threshold likelihood. Example conditions may include short circuits having at least a threshold duration (e.g., hard short circuits, short circuits longer than 5 ms, etc.), a first short circuit of a welding operation, a measured output current or measured output power of more than a threshold, a measured input current or measured input power of more than a threshold, and/or any other desired conditions.

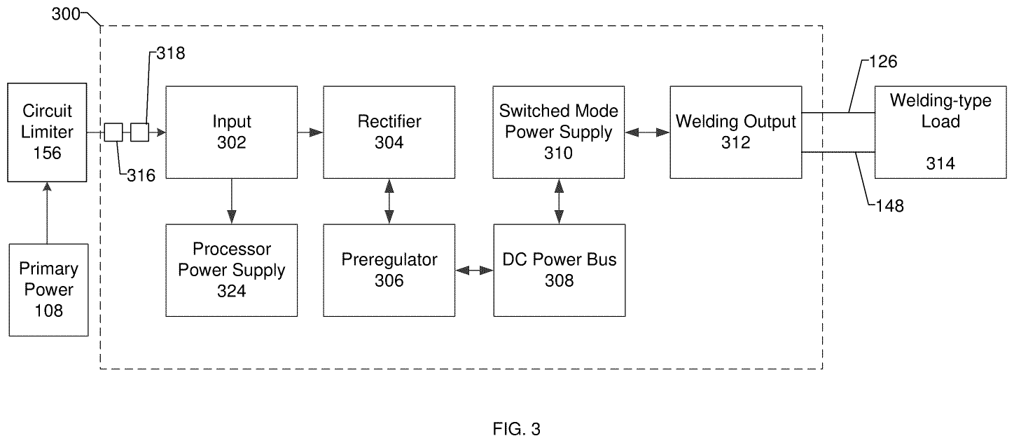

FIG. 3 is a block diagram of example power conversion circuitry 300 that may be used to implement the power conversion circuitry 110 of FIGS. 1 and/or 2. The power conversion circuitry 300 includes an input 302 configured to receive the AC input power from the primary power 108, which is controlled by the circuit limiter 156. The primary power 108 may be the AC power grid, an engine/generator set, and/or a battery-powered inverter-type generator. The example primary power 108 provides single phase AC power to the input 302.

The power conversion circuitry 300 includes a rectifier circuit 304 and a preregulator circuit 306 to condition the AC power received at the input 302 to DC power at a DC power bus 308. For example, the preregulator 306 may convert (e.g., boost) the DC voltage received from the rectifier 304 to supply a high voltage DC bus 308. A switched mode power supply 310 converts power from the DC power bus 308 to output welding power to a welding output 312.

The welding output 312 converts power from the DC power bus to welding-type power to a welding-type load 314, for example a welding torch.

A processor power supply 324 (e.g., a power transformer that draws power from a single phase of the AC power connected to the input 302) may provide power for the control circuitry 112 using the power received at the input 302. The preregulator 306, the switched mode power supply 310, and/or the welding output 312 may be controlled by the control circuitry 112 to provide dynamic welding loads and to reduce or prevent tripping of the circuit limiter 156.

To reduce or prevent trips of AFCI-type circuit breakers, the control circuitry 112 controls the preregulator 306 to limit the input current received from the primary power 108 to less than an AFCI primary weld current limit. For example, for an AFCI-type circuit breaker rated for 30 A, the control circuitry 112 may control the preregulator 306 to limit the input current to less than 30 A RMS and/or 42 A peak (e.g., 30 A RMS √2≈42.4 A peak). Additionally or alternatively, the control circuitry 112 may limit the current received from the primary power 108 during weld starts (e.g., approximately the first 500 ms of weld current output) to an AFCI primary start limit current. For example, for an AFCI-type circuit breaker rated for 30 A, the control circuitry 112 may limit the current to less than 25 A RMS and/or 35.4 A peak (e.g., 25 A RMS √2≈35.4 A peak).

To control the preregulator 306 based on the input current, the example power supply 102, 202 includes a current sensor 316, which provides a signal to the control circuitry 112 representative of the input current to the power conversion circuitry 110. In some examples, the current sensor 316 includes circuitry to convert or filter the measured current to a desired current measurement (e.g., AC magnitude, AC peak, RMS, average, etc.).

To reduce or prevent trips of battery-powered inverter and/or generator current limiter trips, the example control circuitry 112 controls the switched mode power supply 310 to reduce the welding current and/or power output during and/or following high-power events. For example, hard short circuits (e.g., short circuits having a duration of 5 ms or more) are generally higher power events that draw more power from the DC power bus 308, thereby requiring the preregulator 306 to increase current draw from the primary power 108 to sustain the target DC bus voltage. To reduce the power drawn during higher power events, the example control circuitry 112 controls the switched mode power supply 310 to decrease the weld current at a higher slope for hard short circuits than for non-hard short circuits. In some examples, the control circuitry 112 controls the switched mode power supply 310 to decrease the current using a step change (e.g., changing as fast, or nearly as fast, as the control loop can respond) to a low current immediately after the hard short clears. The low current may be based on the weld process, the wire, the gas and/or material thickness for the welding operation.

The control circuitry 112 may similarly reduce the power output in response to the first short circuit of a welding operation. During the start of a wire fed weld, the control circuitry 112 ramps up the wire feed speed from a starting (run-in) wire feed speed to the configured setpoint speed, and ramps up the voltage from a starting voltage to the configured setpoint voltage. During the initial state of the weld (e.g., leading up to and for a predetermined period following a first short circuit of the weld), the control circuitry 112 may hold the wire feed speed at a predetermined speed prior to ramping up the speed to the setpoint speed and/or hold the voltage at a predetermined voltage prior to ramping up the voltage to the setpoint voltage. The predetermined speed and/or predetermined voltage may be based on a lower voltage limit to maintain the welding arc, and/or the weld process, the wire, the gas and/or the material thickness.

To grow a desired ball size during a short arc welding operation, the example control circuitry 112 uses a slower current decrease following short circuits that do not satisfy thresholds or conditions to use a faster current decrease. The slower current decrease may be beneficial for most short circuits in the welding operation to grow a ball of a consistent size on the wire. The control circuitry 112 may implement a threshold for short circuit duration, such that the control circuitry 112 controls the current decrease using a first, higher current ramp rate in response to short circuits of at least a threshold duration, and a second, lower current ramp rate in response to short circuits of less than the threshold duration.

The example power supply 102, 202 further includes a voltage sensor 318 to monitor a voltage of the primary power 108. The voltage sensor 318 provides to the control circuitry 112 a signal representative of the voltage at the input 302. The control circuitry 112 may monitor the voltage signal during a welding operation to identify when a loss of voltage has occurred at the input 302 (e.g., from a disconnection of the primary power 108 via the circuit limiter 156). The example welding power supplies 102, 202 may have sufficient hold up time (e.g., time during which the control circuitry 112 has sufficient power from internal energy storage devices to execute instructions, store data, accept input, provide output, etc.) to save user settings, error logs, and/or other data to a non-volatile memory (e.g., the storage device 123). When the example control circuitry 112 detects the loss of voltage during a weld from the voltage sensor 318, the control circuitry 112 stores an indication of a circuit limiter trip event in the storage device 123.

When input power is established at the power supply 102, 202, the control circuitry 112 checks for the indication of the circuit limiter trip event (e.g., in the storage device 123 or other non-volatile memory). In response to identifying the indication of the breaker trip, the control circuitry 112 notifies the user (e.g., via the user interface 114) that a circuit breaker trip has occurred. In some examples, the control circuitry 112 may further output suggestions to the user to adjust circuit limiter settings and/or welding parameters should be adjusted to reduce or prevent future circuit limiter trips. The control circuitry 112 may identify suggested changes based on, for example, the current or more recent current limiter setting and/or the welding parameters used and stored at the time of the current limiter trip.

During conventional short arc welding operations, the energy during each short circuit heats the welding wire until the wire fuses open, after which the energy after the short circuit melts the end of the wire into a ball. The size of the ball on the end of the wire is proportional to the energy after the short has cleared.

When the welding operation is starting, the wire may be relatively cold compared with the temperature of the wire during later portions of the welding operation. The current required to clear the first short circuit (e.g., the increased welding current to heat the wire to the point at which the wire fuses open) is typically substantially higher than subsequent short circuits. If the current is lowered at the normal rate used after short circuits, the current will take a relatively long time to decrease, and the higher energy will create a relatively large ball at the end of the wire. When the first large ball short circuits to the weld puddle, more current is needed than nominal to clear that short circuit, but less than the initial short. For this reason, the current needed to clear the first several short circuits in a welding operation decreases with each short until the process stabilizes.

The example control circuitry 112 decreases the current at a higher rate (e.g., a step change, or a change as fast or nearly as fast as the control loop can respond) to reach the nominal ball size and clear current more quickly. In some examples, the control circuitry 112 may use the higher rate of current decrease for a predetermined time period following the start of the welding operation. The control circuitry 112 may set the predetermined time period as a fixed time period, or may determine the predetermined time period based on the wire type, the wire diameter, the material thickness, and/or other welding parameters. Additionally or alternatively, the control circuitry 112 may use the higher rate of current decrease until a weld puddle of at least a threshold size has been established. The control circuitry 112 may determine the puddle size based on travel speed, wire feed speed, output current, output voltage, and/or any other weld parameters.

In some examples, the control circuitry 112 identifies the clearing of a short circuit by comparing an output voltage of the power conversion circuitry 110 to a threshold, and responds to the voltage increasing above the threshold by decreasing the current. In some other examples, the control circuitry 112 may monitor the output voltage to predict the time at which the short circuit will clear, and control the power conversion circuitry 110 to decrease the current carlier than when reacting to the output voltage. Example techniques that may be used by the control circuitry 112 to predict the clearing of a short circuit are disclosed in U.S. Pat. No. 10,239,146, assigned to Illinois Tool Works Inc. The entirety of U.S. Pat. No. 10,239,146 is disclosed herein by reference.

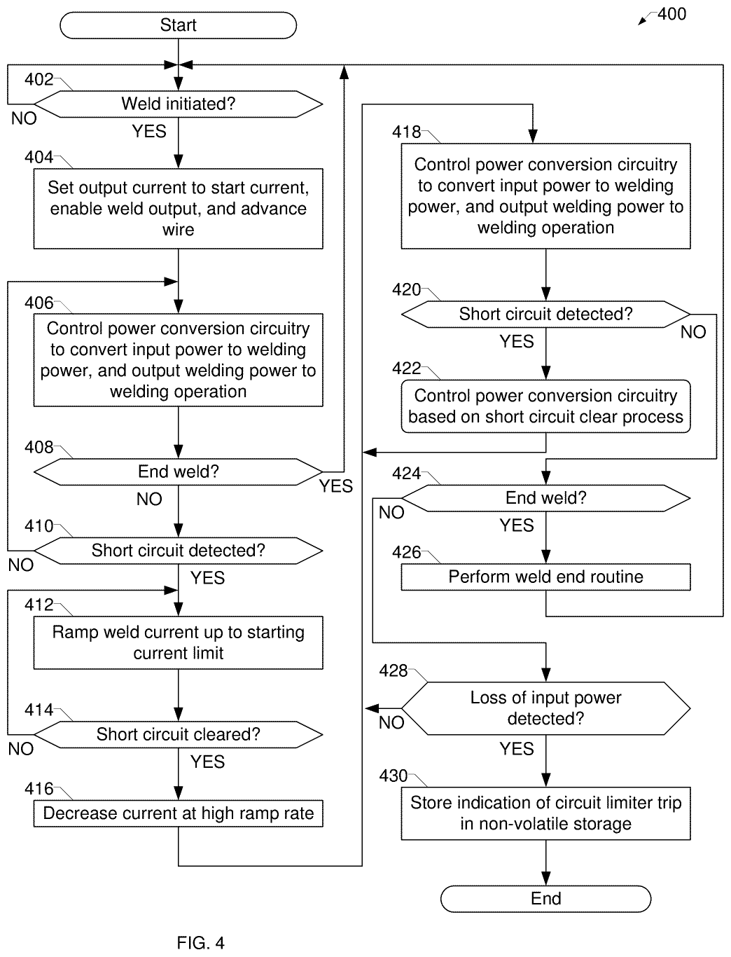

FIG. 4 is a flowchart representative of example machine readable instructions 400 which may be executed by the control circuitry 112 of FIGS. 1 and/or 2 to control the power conversion circuitry 110 to reduce nuisance trips of circuit limiters (e.g., the circuit limiter 156) while welding.

At block 402, the control circuitry 112 determines whether a weld has been initiated. For example, the control circuitry 112 may determine whether a trigger of the welding torch 106 has been pulled, or if there is otherwise welding current output by the power conversion circuitry 110. If a weld is not initiated, control returns to block 402 to await welding.

If a weld has been initiated (block 402), at block 404 the control circuitry 112 sets an output current to a start current, controls the power conversion circuitry 110 to enable the weld output, and controls a wire feeder (e.g., the wire feeder 104, the integrated wire feeder 204) to advance the wire. At block 406, the control circuitry 112 controls the power conversion circuitry 110 to convert the input power (e.g., primary power 108) to welding power, and to output the welding power to a welding operation. Converting the input power to the welding power may involve controlling the preregulator 306 of FIG. 3 to supply the DC power bus 308 with a bus voltage, and converting power from the DC power bus to welding output via the switched mode power supply 310.

At block 408, the control circuitry 112 determines whether the weld is ending. For example, the control circuitry 112 may determine whether a trigger of the welding torch 106 has been released to stop the weld. If the weld is ending (block 408), control returns to block 402. If the weld is not ending (block 408), at block 410 the control circuitry 112 determines whether a short circuit has been detected (e.g., a first short circuit of the weld operation). The control circuitry 112 may detect the short circuit based on a monitored output voltage of the power conversion circuitry 110. If a short circuit has not been detected (block 410), control returns to block 406 to continue controlling the power conversion circuitry 110 and wire feeder 104.

When a short circuit is detected (block 410), at block 412 the control circuitry 112 increases or ramps up the weld current to a starting current limit. For example, the starting current limit may be determined based on a type and/or rated amperage of current limiter 156 identified at the control circuitry 112 (e.g., via the user interface), a current limit of the power conversion circuitry 110, and/or weld parameters such as wire type, wire diameter, material thickness, wire feed speed, and/or other weld parameters. At block 414, the control circuitry 112 determines whether the short circuit has been cleared. If the short circuit has not been cleared (block 414), control returns to block 412 to continue ramping up the weld current.

When the short circuit has been cleared (block 414), at block 416 the control circuitry 112 controls the power conversion circuitry 110 to decrease the current at a high ramp rate. For example, the control circuitry 112 may control the power conversion circuitry 110 to step down the current as quickly, or nearly as quickly, as the control loop can respond.

In some examples, for a predetermined period starting at the beginning of the welding operation or starting at the clearing of the first short circuit (e.g., an initial welding phase), the control circuitry 112 controls the power conversion circuitry 110 and/or the wire feeder 104 to limit the welding output voltage to less than a voltage setpoint and/or limit the wire feed speed to less than a wire feed speed setpoint. For example, the voltage and/or the wire feed speed may be ramped up during the initial welding phase or held constant at a predetermined value. At the end of the predetermined period or initial welding phase, the control circuitry 112 controls the power conversion circuitry 110 and/or the wire feeder 104 to use the setpoint voltage and/or wire feed speed setpoints.

At block 418, the control circuitry 112 controls the power conversion circuitry 110 to convert the input power (e.g., primary power 108) to welding power, and to output the welding power to a welding operation. Converting the input power to the welding power may involve controlling the preregulator 306 of FIG. 3 to supply the DC power bus 308 with a bus voltage, and converting power from the DC power bus to welding output via the switched mode power supply 310. Block 418 may be performed in a similar or identical manner to block 406.

At block 420, the control circuitry 112 determines whether a short circuit has been detected. The control circuitry 112 may detect the short circuit based on a monitored output voltage of the power conversion circuitry 110.

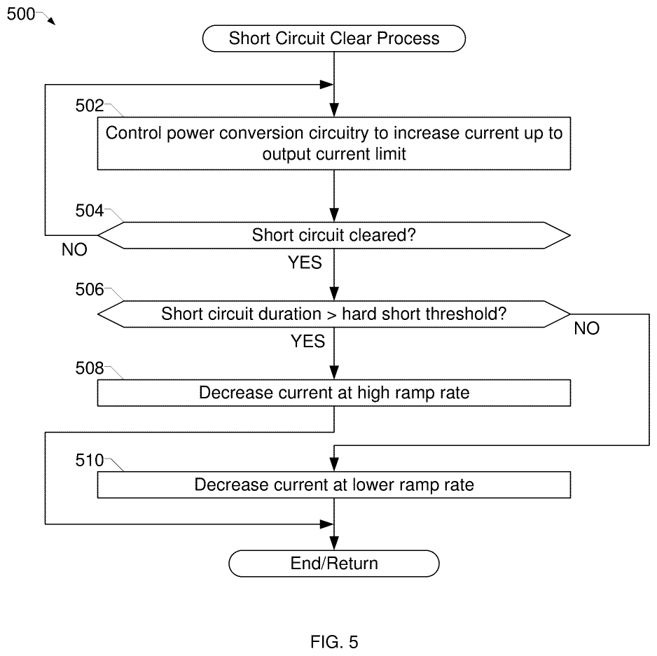

When a short circuit is detected (block 420), at block 422 the control circuitry 112 controls the power conversion circuitry 110 based on a short circuit clearing process. An example short circuit clearing process increases the current during the short circuit until the short circuit is cleared (e.g., re-strikes an arc), and may adjust a response to the short circuit if the short circuit duration exceeds a threshold (e.g., a threshold representative of a hard short circuit). An example method to implement block 422 is disclosed below with reference to FIG. 5. Control then returns to block 418 to continue controlling the power conversion circuitry 110.

If a short circuit has not been detected (block 420), at block 424 the control circuitry 112 determines whether the weld operation is ending. For example, the control circuitry 112 may determine whether a trigger of the welding torch 106 has been released to stop the weld. If the weld is ending (block 424), at block 426 the control circuitry 112 performs a weld end routine (e.g., post-flow of shielding gas, etc.) and control returns to block 402.

If the weld is not ending (block 424), at block 428 the control circuitry 112 determines whether a loss of input power has been detected. For example, the control circuitry 112 may monitor the voltage sensor 318 of FIG. 3 to determine whether there is a loss of voltage to the input 302. If there is not a loss of power detected (block 428), control returns to block 418 to continue controlling the power conversion circuitry 110.

If there is a loss of power detected (block 428), at block 430 the control circuitry 112 stores an indication of a circuit limiter trip in a non-volatile storage (e.g., the storage device 123). The storing of the indication is performed during a hold-up time, or while the welding power supply is being powered on back-up battery power. The example instructions 400 then end.

FIG. 5 is a flowchart representative of example machine readable instructions 500 which may be executed by the control circuitry 112 of FIGS. 1 and/or 2 to control the power conversion circuitry 110 based on short circuit clear process. The example instructions 500 may be executed to implement block 422 of FIG. 4.

At block 502, the control circuitry 112 controls the power conversion circuitry 110 to increase the output welding current, up to an output current limit. For example, the output current limit may be determined based on a type and/or rated amperage of current limiter 156 identified at the control circuitry 112 (e.g., via the user interface), a current limit of the power conversion circuitry 110, and/or weld parameters such as wire type, wire diameter, material thickness, wire feed speed, and/or other weld parameters.

At block 504, the control circuitry 112 determines whether the short circuit has been cleared. For example, the control circuitry 112 may determine whether the output voltage exceeds a threshold voltage representative of the presence of the short circuit. If the short circuit has not been cleared (block 504), control returns to block 502 to continue outputting the current.

When the short circuit is cleared (block 504), at block 506 the control circuitry 112 determines whether the duration of the short circuit is at least a threshold duration for a hard short circuit. In some examples, the threshold duration is approximately 5 ms, but may be another threshold and/or may depend on the weld parameters.

If the short circuit duration satisfies the threshold to be considered a hard short circuit (block 506), at block 508 the control circuitry 112 controls the power conversion circuitry 110 to decrease the current at a first, higher ramp rate. For example, the higher ramp rate may be a step change in current and/or at or near an upper limit rate at which the power conversion circuitry 110 is capable to decrease the current.

If the short circuit duration does not satisfy the threshold to be considered a hard short circuit (block 506), at block 510 the control circuitry 112 controls the power conversion circuitry 110 to decrease the current at a second, lower ramp rate than the first ramp rate for hard short circuits. The lower ramp rate may be based on the welding parameters, such as voltage, wire feed speed, current, wire type, wire diameter, time between short circuits, duration of the short circuit, and/or any other parameters.

After decreasing the current at the higher ramp rate (block 508) or the lower ramp rate (block 510), the example instructions 500 may end and return control to block 424 of FIG. 4.

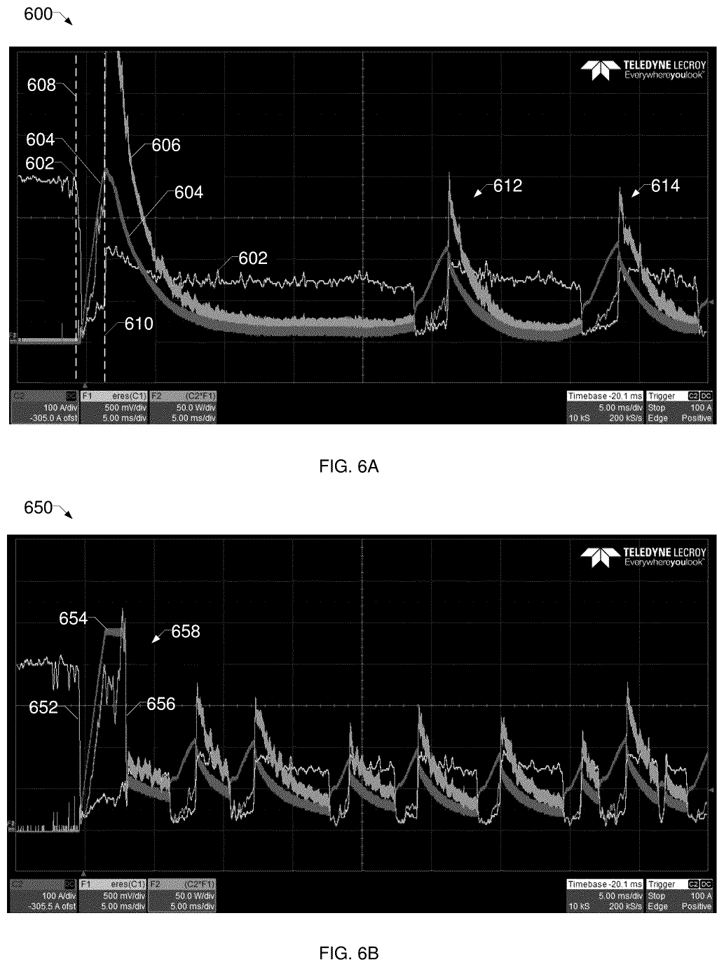

FIG. 6A is a graph 600 illustrating an output of a welding power supply during a conventional short circuit clearing process that is subject to nuisance trips of a current limiter. The example graph 600 illustrates a measured output voltage 602, a measured output current 604, and a resulting output power 606.

At time 608, the welding output voltage drops due to the first short circuit of a welding operation. During the short circuit, the current 604 and power 606 increase significantly to clear the short circuit. When the short circuit is cleared at time 610, the current is decreased at a slower rate to a lower current. The resulting power during the short circuit exceeds 18 kilowatts (kW), which significantly increases the likelihood of a current limiter trip. The next two short circuits 612, 614 have power of approximately 10 kW. As illustrated in FIGS. 6 A and 6B, the settling time from the first short circuit to the nominal short circuit is significantly longer in conventional power supplies than in the example power supply 102, 202.

FIG. 6B is a graph 650 illustrating an output of a welding power supply (e.g., the power supply 102, 202 of FIG. 1 or 2) during a disclosed example short circuit clearing process implemented using a control method that reduces or prevents nuisance trips of a current limiter. The graph 650 includes a measured output voltage 652, a measured output current 654, and a resulting power 656. In contrast with the output illustrated in FIG. 6A, the output current 654 is decreased significantly faster after an initial short circuit 658, which also significantly decreases the output power 656 output during the initial short circuit 658 compared to the initial short circuit illustrated in FIG. 6A. Additionally, the time between short circuits is reduced and peak current 654 settles to a nominal value faster and in fewer short circuits than using the conventional control represented in FIG. 6A.

Returning to FIG. 1, reducing the input current and/or the output welding-type current may be based on a type and/or amperage rating of the current limiter 156. To this end, in some examples the user interface 114 enables an operator to input a type of the current limiter 156 and/or an amperage rating of the current limiter 156.

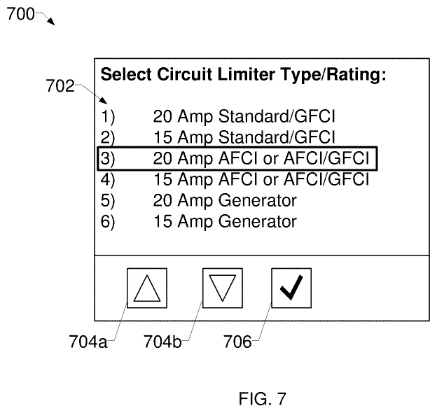

FIG. 7 is an example user interface 700 which may implement the user interfaces 114 of FIGS. 1 and/or 2 to receive an input specifying a type and/or amperage limit associated with a circuit limiter 156 at an input of the power supply 102, 202. The example user interface 700 may be accessed via a user interface of the power supply 102, 202, such as by navigating menus and/or via a prompt in response to identifying that the current limiter tripped in a prior welding operation.

As illustrated in FIG. 7, the user interface 700 allows the user to select a type of current limiter and/or a rated current value for the current limiter from a list 702 of types and/or ratings. The control circuitry 112 may then adjust control of the power conversion circuitry 110 based on the selected type and/or rating of the current limiter 156 to reduce or prevent nuisance trips. Example parameters that may be adjusted based on the type and/or rating may include current limits, current ramp rates (e.g., to decrease the current after a hard short circuit), output voltage, wire feed speed, current, and/or any other parameters.

The interface 700 may include hardware and/or software controls to select a type and/or rating from the list. For example, the interface 700 includes navigation buttons 704a, 704b to navigate the list 702 to highlight a selection, and an acceptance button 706 to confirm a desired selection. Example types of current limiters may include standard or conventional breakers; GFCI-type breakers, AFCI-type breakers, combination breakers, generator current limiters, and/or any other type of circuit limiter. In the example list 702, GFCI-type breakers are combined into the same selections as corresponding non-GFCI breakers, but may be listed separately in the interface 700.

In some examples, the control circuitry 112 may use the same parameters for different selections in the list 702 when different selections are not meaningfully different for avoiding trips, but may be present to avoid confusion to the operator.

In some examples, the user interface 700 allows the user to adjust control settings (e.g., the primary weld current limit, primary start current limit, secondary weld current limit, secondary weld voltage limit, material thickness selection range, etc.) and/or to enable and/or disable certain controls (such as the initial wire speed ramp, initial voltage ramp, etc.) for one or more of the current limiter type and/or rating selections.

Alternatively, the type and/or rating of the current limiter 156 may be identified using other types of inputs, such as physical switches, jumpers, and/or any other type of input device(s).

The present methods and systems may be realized in hardware, software, and/or a combination of hardware and software. The present methods and/or systems may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may include a general-purpose computing system with a program or other code that, when being loaded and executed, controls the computing system such that it carries out the methods described herein. Another typical implementation may comprise an application specific integrated circuit or chip. Some implementations may comprise a non-transitory machine-readable (e.g., computer readable) medium (e.g., FLASH drive, optical disk, magnetic storage disk, or the like) having stored thereon one or more lines of code executable by a machine, thereby causing the machine to perform processes as described herein. As used herein, the term “non-transitory machine-readable medium” is defined to include all types of machine readable storage media and to exclude propagating signals.

As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present disclosure. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A welding power supply, comprising:
power conversion circuitry configured to convert input power to welding power, and to output the welding power; and
control circuitry configured to:
in response to detecting a short circuit between a welding electrode and a workpiece, controlling the power conversion circuitry to increase a current of the welding power; and
in response to identifying a predetermined condition that would cause a circuit limiter connected to the input power to trip, control the power conversion circuitry to reduce at least one of an input current of the input power or an output current of the welding power to avoid tripping the circuit limiter.

2. The welding power supply as defined in claim 1, wherein the power conversion circuitry comprises:
a preregulator circuit configured to convert the input power to supply a DC bus; and
a switched mode power supply configured to convert power from the DC bus to output the welding power.

3. The welding power supply as defined in claim 2, wherein the control circuitry is configured to control the preregulator circuit to limit the input current of the input power to supply the DC bus.

4. The welding power supply as defined in claim 2, wherein the control circuitry is configured to control the switched mode power supply to reduce the output current of the welding power.

5. The welding power supply as defined in claim 1, wherein the control circuitry is configured to:
monitor an input voltage of the input power;
in response to a loss of input voltage during a welding operation, store an indication of a breaker trip in a non-volatile storage device prior to loss of power to the control circuitry and the storage device; and
in response to identifying the indication of the breaker trip in the storage device, outputting an alert indicating that a circuit breaker trip occurred at the input power.

6. The welding power supply as defined in claim 1, wherein the control circuitry is configured to:
in response to detecting a clearing of the short circuit when the short circuit is a first short circuit of a welding operation or the short circuit persisted longer than a predetermined threshold time period prior to the clearing of the short circuit, control the power conversion circuitry to decrease the current at a first rate; and
in response to detecting a clearing of the short circuit when the short circuit persisted less than the predetermined threshold time period and the short circuit is not the first short circuit of the welding operation, control the power conversion circuitry to decrease the current at a second rate that is slower than the first rate.

7. The welding power supply as defined in claim 1, further comprising a user interface configured to receive an input identifying at least one of a type of circuit limiter connected to the input power or an amperage associated with the circuit breaker connected to the input power.

8. The welding power supply as defined in claim 7, wherein the control circuitry is configured to control the power conversion circuitry to limit the input current of the input power drawn by the power conversion circuitry to less than a first limit based on the input.

9. The welding power supply as defined in claim 8, wherein the first limit is not more than 30 Amperes.

10. The welding power supply as defined in claim 7, wherein the input comprises at least one of a standard circuit breaker type, an arc fault circuit interrupter circuit breaker type, a ground fault circuit interrupter type, a combination arc fault circuit interrupter-ground fault circuit interrupter circuit breaker type, or a generator circuit limiter type.

11. A welding power supply, comprising:
power conversion circuitry configured to convert input power to welding power, and to output the welding power;
a user interface configured to receive an input identifying at least one of a type of circuit limiter connected to the input power or an amperage associated with a circuit limiter connected to the input power; and
control circuitry configured to control the power conversion circuitry to reduce nuisance trips of the circuit limiter.

12. The welding power supply as defined in claim 11, wherein the control circuitry is configured to control the power conversion circuitry to limit an input current of the input power drawn by the power conversion circuitry to less than a first limit based on the input.

13. The welding power supply as defined in claim 12, wherein the control circuitry is configured to control the power conversion circuitry to limit the input current of the input power to less than a second limit during a first predetermined time period of a welding operation.

14. The welding power supply as defined in claim 12, wherein the first limit is not more than 30 Amperes.

15. The welding power supply as defined in claim 11, wherein the control circuitry is configured to, based on the input, control a wire feeder to limit a wire feed speed to less than a wire feed speed setpoint for a predetermined duration following clearing of a first short circuit of a welding operation.

16. The welding power supply as defined in claim 11, wherein the control circuitry is configured to, based on the input, control the power conversion circuitry to limit a voltage of the welding power to less than a voltage setpoint for a predetermined duration following clearing of a first short circuit of a welding operation.

17. The welding power supply as defined in claim 11, wherein the input comprises at least one of a standard circuit breaker type, an arc fault circuit interrupter circuit breaker type, or a ground fault circuit interrupter type, a combination arc fault circuit interrupter-ground fault circuit interrupter circuit breaker type, or a generator circuit limiter type.

18. The welding power supply as defined in claim 11, wherein the control circuitry is configured to, based on the input, control the power conversion circuitry to increase a current ramp rate for decreasing a welding current of the welding power in response to clearing of a first short circuit of a welding operation.

19. The welding power supply as defined in claim 11, wherein the control circuitry is configured to, based on the input, control the power conversion circuitry to increase a current ramp rate for decreasing a welding current of the welding power in response to clearing of short circuits that have at least a predetermined duration.

20. The welding power supply as defined in claim 19, wherein the control circuitry is configured to, based on the input, control the power conversion circuitry to increase the current ramp rate to an upper limit of the current ramp rate of the power conversion circuitry in response to the clearing of short circuits that have at least the predetermined duration.
